(19) United States
(12) Patent Application Publication
(10) Pub. No.: US 2011/0304437 A1
(43) Pub. Date: Dec. 15, 2011

(54) Antenna and Sensor System for Sharply Defined Active Sensing Zones

(75) Inventors: Bill Beeler, Harvest, AL (US); Arun Venkatasubramanian, Somerville, MA (US)

(73) Assignee: Plus Location Systems USA LLC, Huntsville, AL (US)

(21) Appl. No.: 13/153,444

(22) Filed: Jun. 5, 2011

Related U.S. Application Data
(60) Provisional application No. 61/353,109, filed on Jun. 9, 2010.

(51) Int. Cl. H01Q 1/52; H04Q 5/22; H04W 4/00; H01Q 19/18; H01P 11/00

(52) U.S. Cl. 340/10.1; 343/841; 343/834; 29/600

(57) ABSTRACT

A sensor system having a sharply defined zone of active sensing comprising a compound antenna system comprising an antenna structure disposed in relation to a shield structure and spaced from the shield structure, the shield structure having an open aperture in front of the antenna structure in the direction of a lobe of sensitivity of the antenna structure. In various embodiments, the shield structure may be layered on the inside between the antenna and the shield structure with an RF absorbing material. The aperture may be formed in part by adjustable panels and the antenna spacing from the aperture may be adjustable by adjusting an antenna mounting position within the shield. The compound antenna system may be coupled to a receiver having a threshold response based on the compound antenna system response characteristic.

### RELATED APPLICATIONS

This application claims the benefit under 35 USC 119(e) of U.S. Provisional Application Ser. No. 61/353,109 titled “Antenna Assembly that Creates Sharply Defined and Adjustable Zones of Illumination,” filed Jun. 9, 2010 by Beeler et al., which is hereby incorporated herein by reference in its entirety.

### BACKGROUND

1. Field of the Invention

The present invention pertains generally to the field of antenna and sensor systems, more particularly to systems producing precise zone illumination and responsiveness for use with various systems, for example, RFID tags, location tags, security tags and sensors.

2. Background of the Invention

Within the field of RFID tracking of people and objects, it is often desired to track people or objects within a specific zone. For example, an RFID application may involve detection of people moving through a doorway, or crossing a point in a hallway or aisle without falsely triggering on people just outside the zone of interest. It may be desired to detect and locate objects on a conveyor without triggering on objects on carts next to the conveyor. Applicants have found that conventional systems typically offer little control over the coverage zone and may have indistinct regions of fringe operation at the edge of the zone. Thus, there is a need for improved zone definition for RFID zone coverage systems while keeping the number and complexity of sensor components to a minimum.

### BRIEF DESCRIPTION OF THE INVENTION

The present invention relates to a sensor system having a sharply defined zone of active sensing comprising a compound antenna system comprising an antenna structure disposed in relation to a shield structure and spaced from the shield structure, the shield structure having an open aperture in front of the antenna structure in the direction of a lobe of sensitivity of the antenna structure. In various embodiments, the shield structure may be layered on the inside between the antenna and the shield structure with an RF absorbing material. The aperture may be formed in part by adjustable panels and the antenna spacing from the aperture may be adjustable by adjusting an antenna mounting position within the shield. The compound antenna system may be coupled to a receiver having a threshold response based on the compound antenna system response characteristic.

In one embodiment, the shield structure may be disposed or extending forward from the antenna structure toward the coverage zone. The shield structure may have an open aperture between the antenna structure and the coverage zone. The shield structure may also surround the antenna structure. The open aperture may be configured for allowing direct line of sight radio frequency communication between the antenna structure and objects within the coverage zone. The shield structure may be configured for providing radio frequency attenuation and/or blocking for signals from or to objects outside of the coverage zone.

In one aspect of the invention, an edge of the shield structure may be aligned between the antenna structure and an edge of the coverage zone for enhancing a response slope of the compound antenna structure.

In a further aspect of the invention, the receiver determines an amplitude property of the received signal and compares the amplitude property with a predetermined threshold to determine whether the signal is from within the active region. The amplitude may be related to signal voltage, power, frequency, periodicity, duration or other characteristics. The threshold may be fixed or adjustable. Alternatively, the receiver gain and sensitivity may be adjustable relative to the threshold. In one embodiment, the threshold may have a different value for each tag. The threshold may be based on an offset relative to a maximum signal amplitude value. The threshold may be based on a maximum amplitude slope as a function of a path through the active zone. In a detail exemplary embodiment, the system may be configured to receive ultra-wideband signals. The system may employ a Vivaldi antenna. The Vivaldi antenna may be disposed within a tapered reflector of various shapes, particularly a rectangular cross section “cow bell” shaped reflector.

In a further aspect of the invention, the aperture may be characterized by a length and width, the greatest of which is at least one wavelength wide, preferably at least two wavelengths wide and capable of operation less than five wavelengths wide, preferably less than ten wavelengths wide.

In a further aspect of the invention, the aperture is spaced at least one wavelength from a nearest end of the antenna element, preferably at least two wavelengths from the antenna element.

In one variation, the shield box may be equal to the dimensions of the aperture and the end of the box is the aperture. In a further variation of the invention, the aperture may be formed in a partition wall (alternatively referred to as an end wall) formed at one end of the shield box and the shield box is greater in cross section dimension than the aperture dimension.

The system provides broad uniform coverage in the response zone while providing rapid sharp attenuation at the zone boundaries.

The amplitude response threshold cooperates with the antenna response characteristic to provide a sharply defined response zone boundary.

These and further benefits and features of the present invention are herein described in detail with reference to exemplary embodiments in accordance with the invention.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

The current invention will be more readily understood from the following detailed description, when read in conjunction with the accompanying drawings, in which:

FIG. 1 is a cross section view of an exemplary antenna and sensor system in accordance with the present invention.

FIG. 2 illustrates an exemplary detector system in accordance with the present invention.

FIG. 3 depicts an exemplary plot of received signal strength vs. distance traveled through the active zone.

FIG. 4 is a depiction of the geometry of an exemplary installation for estimating aperture size and active zone dimensions.

FIG. 5 is a bottom perspective view of the sensor system of FIG. 1 showing the antenna element, horn, and aperture.

FIG. 6 illustrates a top down view showing an exemplary plot of a boundary adjusted to encompass a 4 ft×4.5 ft active zone.

FIG. 7 is a perspective view of the exemplary horn reflector of FIG. 1.

FIG. 8 shows a variation of the system of FIG. 1, wherein the shield opens directly to the aperture.

FIG. 9 shows a variation of the system of FIG. 1, wherein the shield is the end wall.

FIG. 10 shows an exemplary embodiment wherein the antenna structure comprises two antennas.

### DETAILED DESCRIPTION OF THE INVENTION

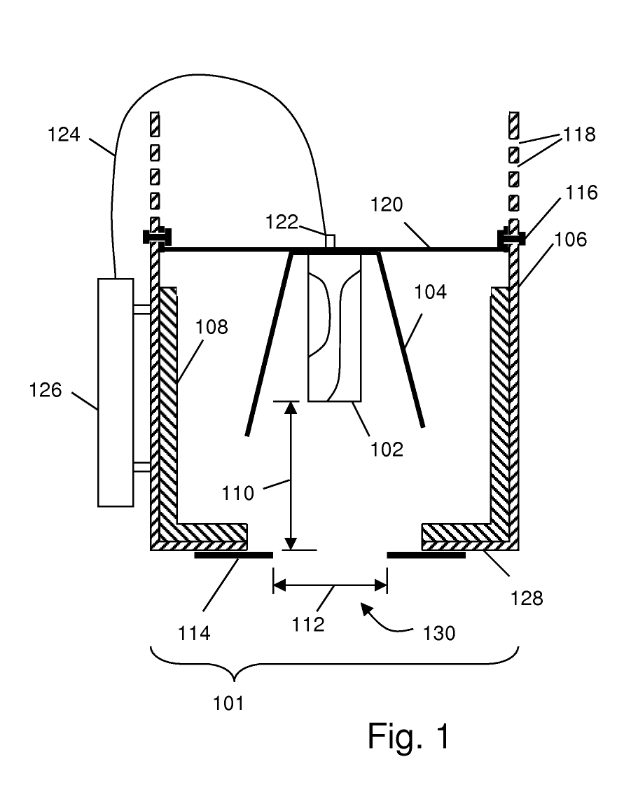

The current invention relates to a highly directional antenna assembly with frequency characteristics designed for precise detection of signals transmitted by active tags within a defined foot print that corresponds to the antenna's illumination area. The illumination area is precisely defined by the field of view, (FOV), that is, observable by the antenna assembly. Illumination area may also be referred to as the antenna coverage area or sensing zone. The antenna assembly of the current invention allows detection of signals transmitted by tags within precisely defined boundaries or edges of the illumination area. When the tags cross such boundaries, i.e., entering or exiting the illumination area, the presence of a tag within the antenna's illumination area could be detected by a reader within a relatively short boundary resolution. The antenna element 102 connects to a reader 126 via a coaxial cable 124 as shown in FIG. 1. The reader 126 includes receiver circuitry that detects the transmitted signals by a tag. Circuitry and software within the reader processes the detected signals for a variety of applications.

One application of the antenna assembly detects the presence of personnel wearing the tags at a predetermined location and within a specified area. The antenna assembly could also have security applications, for example, generating an alarm or locking or unlocking a door when a tag crosses through a precise area.

The FOV is the angular, linear or areal extent of the observable foot print by the antenna. In other words, the FOV also corresponds to the vertical and horizontal angle of coverage or angle of view over which tags could be detected. In one embodiment, the tag comprises a transmitter with radio frequency characteristics that are matched to that of the antenna assembly emitting Ultra-wideband signals in a manner that could be received by the antenna assembly within the antenna assembly's FOV. In one embodiment, the tag transmits Ultra-wideband signals at frequency ranges of anywhere from 3.1 GHz to 10.6 GHz to meet regulatory requirements of the cognizant authorities in various countries, for example 5.925 GHz-7.25 GHz in the US 15.250 rules, 3.1 GHz to 10.6 GHz in the US 15.519 rules, 6.0 to 8.5 GHz in Europe and 7.2 to 10.2 GHZ in Korea. The Ultra-wideband signal could be modulated or unmodulated. The modulation could be based on time, phase or frequency implemented using digital or analog modulation techniques, e.g., AM, FM, PSK, QAM, OFDM, OOK, etc. The modulation could correspond to any parameter such as identity of persons, things or objects. For Ultra-wideband, a reference to wavelength refers to a wavelength of a center frequency of the ultra-wideband signal.

One type of Ultra-wideband signal transmitted by the tags comprises pulses having temporal or non-temporal pulse characteristics, e.g., pulse shapes, durations, positions in time, or amplitudes, suitably selected to satisfy various regulatory requirements associated with the use of spectrum for any application, e.g., detecting persons, things or objects. In this way, the reader coupled to the antenna assembly detects the presence of the tag within the antenna's illumination area based on Ultra-wideband signals detected within the FOV of the antenna assembly. The antenna assembly of the current invention, in combination with the reader, is designed to detect Ultra-wideband signals transmitted from only those tags that are within the antenna assembly FOV and ignore those Ultra-wideband signals that are not within the FOV. In other words, the antenna assembly and reader detects those tags that are within the illumination area and does not detect those that are outside of the FOV. One characteristic of the antenna assembly of the current invention is that it provides a substantially nonlinear transition for detecting the presence of the tag at the boundary edges of the antenna's illumination area.

FIG. 1 is a vertical cross section view of an exemplary antenna and sensor system in accordance with the present invention. The sensor system comprises a receiver 126, which may be a transceiver 126 and an antenna assembly 101. The receiver may also include a computer and processing software as well as network communication interfaces for communicating with other sensors and/or application software systems.

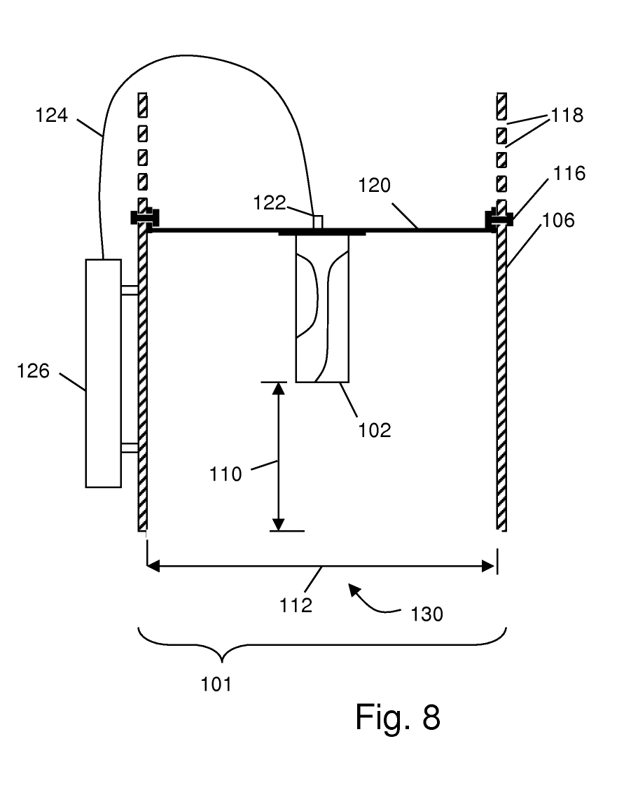

The antenna assembly comprises an antenna 102 shown within a cavity having a predefined aperture. The antenna is spaced from the aperture by one or more wavelengths. The cavity may be formed by a conductive shield shroud around the antenna and extending to the front of the antenna. The cavity may be layered with absorptive material 108 to attenuate RF reflections from the shroud 106. In one alternative, the shield includes an end wall 128 between the antenna and the illuminated space. The end wall 128 provides an edge cutting into the radiation pattern of the antenna and sharpening the edge transition of the antenna response. The end wall may be substantially orthogonal to the center axis of the antenna pattern, and partially closes one end of the shield assembly. In one variation, the shield box 106 may be equal to the dimensions of the aperture 130 and the end of the box is the aperture. See FIG. 8. In a further variation of the invention, (FIG. 1), the aperture may be formed in a partition wall 128 (alternatively referred to as an end wall) formed at one end of the shield box 106 and the shield box 106 is greater in cross section dimension than the aperture dimension.

The antenna of FIG. 1 comprises an antenna radiating element within a reflector. The exemplary reflector is a tapered rectangular pyramid shape with a close end at the antenna feed end and an open end at the radiating end. Other reflectors may be used. The antenna and reflector assembly is mounted on a bracket that may be positioned at one of several locations on the shield assembly. The multiple possible mounting positions allow for adjusting the position of the antenna relative to the aperture to allow for various active area sizes. As shown, the shield assembly is optionally open at the back end (top as pictured) for convenience. The front to back ratio of the antenna assembly is normally sufficient to obviate the need for closing the back end, thus simplifying installation and adjustment.

In one embodiment, the antenna element has broadband characteristics suitable for detecting ultra wideband signals. The antenna element could impedance matched with a feed line using any impedance matching arrangement, such as microstrip line or strip lines. In one embodiment, the antenna element is a co-planar broadband-antenna having metalized areas at both sides of a dielectric layer. Any suitable RF dielectric may be used, including air. Examples of antennas that could be used in the current invention comprise a dipole antenna, monopole antenna, slot antenna, Vivaldi antenna, a patch antenna, end-launch antenna, or other antenna. The antenna element may be linearly or circularly polarized as desired for the particular application.

The antenna element is symmetrically positioned relative to the reflector such that the reflector provides gain to electromagnetic waves transmitted by tags within the FOV of the assembly and attenuates or blocks electromagnetic waves transmitted by tags outside the FOV. In one embodiment, the reflector is bell shaped having an open and closed opposing ends and tapered side surfaces. The openings shapes can be different, and can be fixed or adjustable.

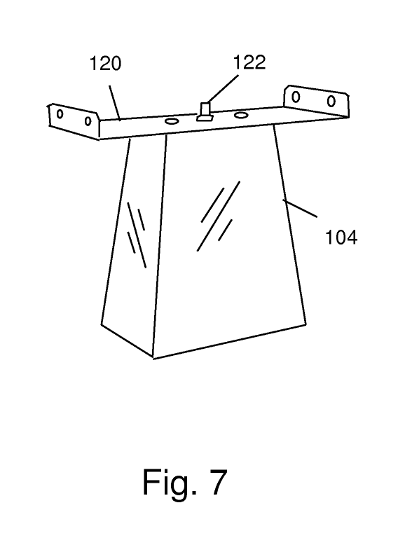

The open end could have straight or curved sides defining various shapes such as square, rectangular or circular shapes. The tapered sides connecting the open end to the closed end could be straight or curved. In one embodiment, the antenna element is fixed to the closed end of a cow bell shaped reflector, as shown in FIGS. 1 and 7. In this way, the antenna element receives reflected Ultra wide band signals that enter the reflector from its open end.

The antenna element and reflector assembly is positioned within a shield cavity or a wave guide made of highly reflective material such as metal. The cavity/wave guide could be sized and shaped to meet various FOV requirements. The cavity could for example be shaped as a rectangular box, for example, 12″ in length, 7″ in width and 6″ in depth. The cavity could also have cylindrical shape as well or any other suitable shape.

The antenna assembly may further comprise a radio frequency (RF) absorber made of suitable material, such as a graphite or carbon impregnated foam that used to line the interior surface of the cavity. The RF absorber material attenuates reflections entering the aperture from wide angles and thus attenuates signals from outside the desired active area. The RF absorber should cover the shield material in front of and to the sides of the active antenna and horn reflector. The use of the RF absorber material allows the shield box to be smaller than otherwise required for similar performance.

One exemplary absorber material is: ECCOSORB® AN-72 or ECCOSORB® LS-24 from Emerson and Cuming Microwave Products. Any suitable absorbing material may be used. In one embodiment, the cavity/wave guide has opposing open ends at its back and front sides such that the open end of the reflector faces an aperture in front of the cavity. The closed end of the reflector is attached to opening at the back side of the cavity/wave guide via a brace 120, In another embodiment, the back side of the cavity/wave guide could be fully or partially closed.

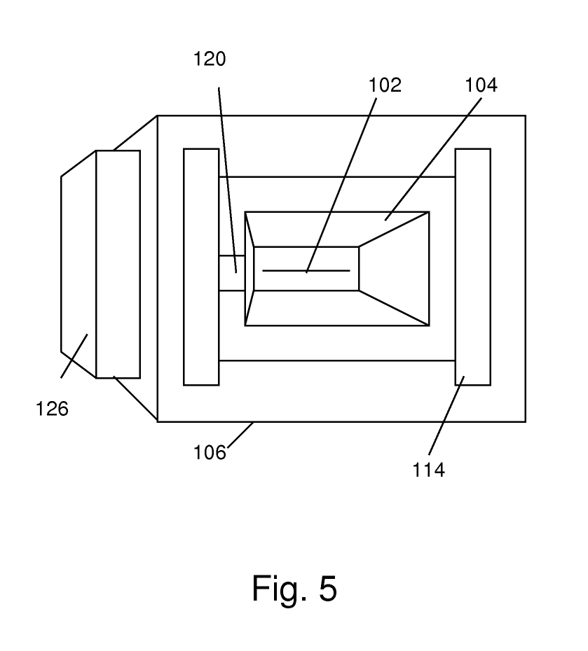

As shown in FIG. 1, the aperture 130 of the cavity has an adjustable entrance aperture on its front side (bottom as pictured). In this way, the aperture could be adjusted to adjust the illumination area of the assembly. Laterally movable panels 114 are shown in FIG. 1 and FIG. 5 to allow adjustment of one dimension of the aperture 130. The panels may be configured with multiple screw positions or slotted screw positions to allow adjustment. Alternatively the panels may be affixed by aluminum tape or adhesive or other attachment methods. In a further embodiment, panels or other mechanisms may be provided for adjustment of both length and width dimensions of the aperture or other features of the shape of the aperture may be adjustable. As shown in FIG. 1, the position of the antenna element and reflector can be adjusted within the cavity as necessary. The antenna element 102 and reflector 104 assembly is mounted on a bracket 120 that may be screwed into the shield assembly 106 at the position shown 116 or any of several alternative positions 118. Other attachment methods may be employed.

FIG. 1 shows a distance 110 from the antenna element to the aperture. The distance is variable and may typically be a minimum of one wavelength or preferably two wavelengths and may typically be a maximum of ten wavelengths.

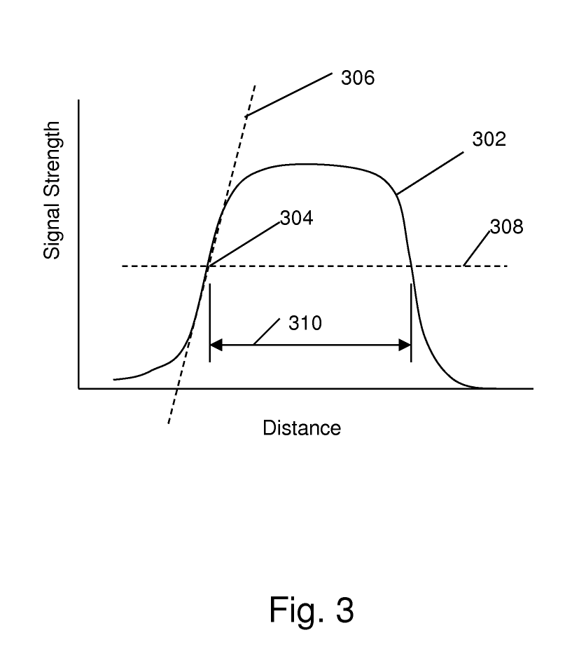

The antenna assembly has a radiation pattern at the antenna element 102 with an angular spread of energy that points towards the mount of the adjustable entrance aperture 114. The radiation pattern of the antenna has a beam width. The beamwidth defines the angular, i.e., azimuth and elevation, extent of the radiation pattern at a prescribed level (e.g., 3 dB). For accurate detection of the tags within the illumination area, the antenna assembly has a narrow beam width (≦25° compared with a dipole, moderate gain (≧10 dBi) inside the illumination area and very sharp gain roll off (≧15 dB/ft) outside the illumination area. The sharp roll off prevents erroneous detection of tags outside the illumination area. See FIG. 3. The opening of the reflector 104 determines the horizontal and vertical axis of the radiation pattern and corresponds to the FOV of the antenna assembly. The aperture 130, which may be fixed or adjustable, acts to further define the radiation pattern for accurate definition of the area of illumination.

In a further aspect of the invention, the aperture 130 may be characterized by a length and width, the greatest of which is at least one wavelength wide, preferably at least two wavelengths wide and capable of operation less than five wavelengths wide, preferably less than ten wavelengths wide. In one embodiment, the aperture 130 may be rectangular and have a length and width dimension. FIG. 1 shows the length dimension 112. FIG. 5 shows a variable length dimension and a fixed width dimension. Other embodiments may have circular or other shapes in accordance with the respective desired active zone. (Length and width are for convenience of discussion and merely indicate two orthogonal dimensions. The terms length and width may be interchangeable)

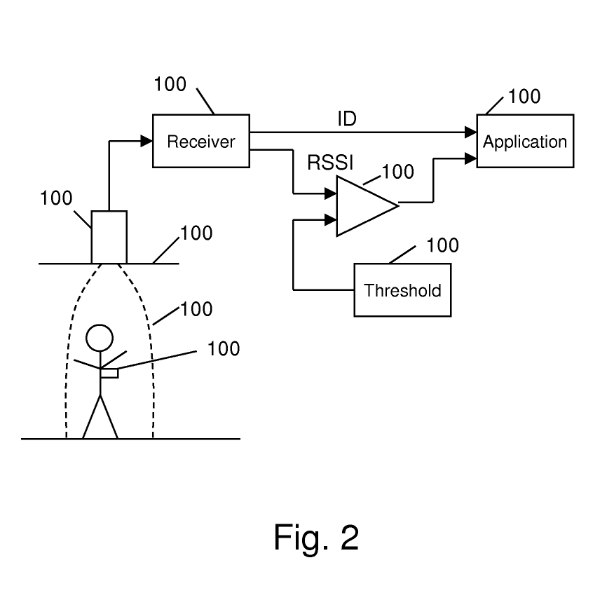

FIG. 2 illustrates an exemplary detector system in accordance with the present invention. Referring to FIG. 2, an antenna system as shown in FIG. 1 may be mounted in a ceiling. The antenna system illuminates an active zone beneath the antenna system. A person wearing a tag enters the active zone and the tag transmits a signal. The signal is then coupled to a receiver and detected by the receiver. The receiver may also determine the signal amplitude. Amplitude may be indicated according to a linear (microvolts) or logarithmic (decibels) scale or other scale as may be preferred. In one embodiment, the signal amplitude may be compared 212 with a predetermined threshold 214 as a further criterion for determining whether the tag is within the active area. If the received signal exceeds the predetermined threshold 214, the received signal and detection information is passed to an application process 210 for further processing. The application process 210 may be for example, a security process, an inventory process, personnel tracking process, or other application process. In a further variation, the threshold 214 may be adjustable to accommodate various receiver/tag sensitivities and strengths or other environmental dimensions or variables. In a further variation, signal strength as well as signal information may be communicated to the application process 210 and the application process may determine the threshold. In one embodiment, a separate threshold may be established for each individual tag.

In one variation, the threshold may be established at a higher level than required for signal detection and demodulation. Thus, any signal meeting the threshold will be usable for reliable detection of any information on the signal, and further, the threshold level and active zone boundary will be minimally affected by noise.

FIG. 3 depicts an exemplary plot of received signal strength vs. distance traveled through the active zone. The distance is in respect to a path, for example a path from edge to edge through the center of the active zone. The amplitude response threshold 308 cooperates with the antenna response characteristic 302 to provide a sharply defined response zone 310. In the fully featured embodiment of FIG. 1, the directional antenna element, horn reflector, shield enclosure, and absorptive covering all contribute to a sharp response slope and reduction of spurious responses. By comparison with typical antenna response lobe shapes, the system of the present invention produces a relatively sharp response edge while providing a relatively wide angle response zone.

Referring to FIG. 3, a point 304 of highest slope of signal strength per distance traveled on the path is shown at 304. The slope is shown as dotted line 306. The slope may be, for example, 15 dB per foot (30 cm) of travel. By selecting a threshold 308 equal to the signal strength at the point of highest slope for a typical tag, the distance variation for different tags of different strengths or different wearer geometries will be minimized, resulting in a more consistently sized active area.

In one embodiment, a setup process may first establish a threshold value based on a maximum slope and then set the active area size by adjusting the antenna height and/or aperture settings. Once the antenna height and aperture settings are set, the threshold may be fine adjusted as necessary. In one alternative, the threshold may be set according to an offset relative to a maximum received value in the center of the active zone, for example six dB below the maximum signal strength. In a further alternative, the maximum signal strength for each tag may be recorded in memory during operation of the system and the threshold may be set for each tag separately, i.e., each tag is received and the ID number is decoded. Memory is accessed for the highest signal value received from the tag, and then the threshold is applied to determine if the tag is within the active zone.

Adjusting the threshold may be accomplished by an equivalent process of adjusting the receiver gain so that a given received signal produces a signal strength equal to the threshold.

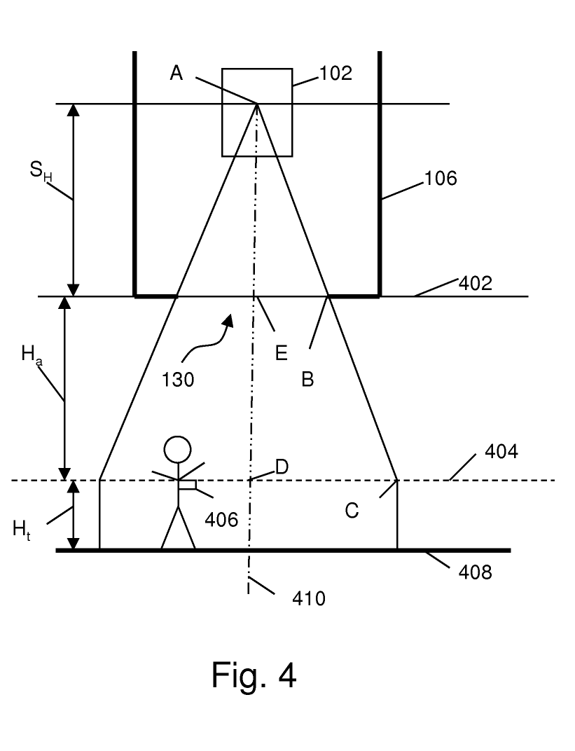

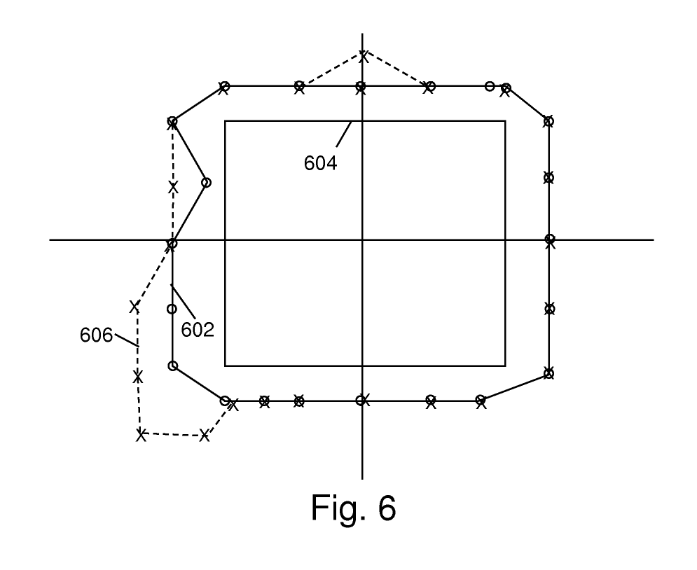

FIG. 4 is a depiction of the geometry of an exemplary installation for estimating aperture size and active zone dimensions. In one aspect of the invention, an edge (B) of the shield structure 106 is aligned between the antenna structure 102 and an edge of the coverage zone (C) for enhancing a response slope (FIG. 3, 306) of the compound antenna system 101. The multiple edges of the aperture can thus define the edges and shape of the active area (See FIG. 6). The inventors have found that in spite of complex antenna field modeling that may be applied to the determination of active zone, the active zone of the exemplary embodiment may be related to the aperture size by the following geometrical considerations. FIG. 4 shows the antenna element 102, the shield box 106 the aperture 130, a mounting plane 402 (typically ceiling height), a floor plane 408, and a tag 406 at a typical tag height 404 (Hₜ) as worn by a typical user. The tag height will be variable for different people and different applications. The system installer may determine a suitable average Hₜ for the expected application. Hₜ=4 feet, 122 cm, works well for office workers wearing name badge tags. Antenna pattern center axis 410 is shown.

Point A is the phase center of the antenna, or effective radiating point of the antenna. Point B is the edge of the aperture. Point C is the lateral extent of the active zone. Point D is the center of the active zone. Point E is the center of the aperture.

For example, it may be desired to find the height of the antenna within the box, i.e., the height adjustment of the antenna within the shield box, that produces a desired active zone dimension. For this calculation, the desired active zone dimension, segment DC is known. The aperture, segment EB is known. The height of the ceiling level 402, H_{c}=Hₐ+Hₜ, is known. The tag height Hₜ is known. Thus,

Hₐ=H_{c}−Hₜ

where,

Hₐ is the height of the aperture above the tag height;

H_{c} is the ceiling height; and

Hₜ is the nominal tag height.

Observing similar triangles, ADC and AEB, the ratios between the two sides of each of the two triangles will be the same:

$$\frac{{S}_{H}}{EB} = \frac{{S}_{H} + {H}_{a}}{DC}$$

With some manipulation,

$${S}_{H} = \frac{{H}_{a} EB}{DC - EB}$$

where,

SH is the antenna mounting height within the shield enclosure, segment AE length;

EB is the length of segment EB, i.e., half of the aperture width; and

DC is the length of segment DC, i.e., half of the active area width dimension.

Thus, the height of the mounting of the antenna within the enclosure can be related to the size of the active area. It can be seen also from FIG. 4 that a different selection of aperture size will result in a different antenna mounting height, S_{H} for the same coverage area.

FIG. 5 is a bottom perspective view of the sensor system of FIG. 1 showing the antenna element, horn, and aperture. Referring to FIG. 5, the antenna element 102 is shown within the tapered horn reflector 104. The horn and antenna assembly is mounted on a bracket 120 within the shield box 106 and directed toward the aperture opening. Adjustable aperture panels 114 are shown. The receiver 126 is shown mounted on the shield box 106.

FIG. 6 illustrates a top down view showing an exemplary plot of a boundary adjusted to encompass a 4 ft×4.5 ft (122 cm×137 cm) active zone. FIG. 6 shows the 4.0 ft (122 cm)×4.5 ft (137 cm) active zone 604 within which a tag should be sensed and read by the reader and should be reliably above threshold. The threshold plot 602 shows the actual plot of threshold measured first detections upon moving from the inactive outer area to the active inner area. The plot 606 shows the first detections without the aperture. The exemplary system for FIG. 6 comprised a 5 inch by 6.5 inch (12.7 cm×16.5 cm) box with a 4.16×6 inch (10.5 cm×15.2 cm) aperture. It can be seen that the aperture can help to constrain the antenna pattern and resulting sensitive region.

FIG. 7 is a perspective view of the exemplary horn reflector of FIG. 1. FIG. 7 shows the horn reflector 104 mounted on the bracket 120 with the RF connector 122 feeding the Vivaldi antenna within the horn reflector 104. The mounting bracket allows positioning of the horn and antenna assembly at a number of possible distances from the aperture in the shield box assembly.

FIG. 8 shows a variation of the system of FIG. 1, wherein the shield opens directly to the aperture. The shield 106 is to the sides and extends forward and in back of the antenna element 102/104. The shield may be rectangular, round, hexagonal or other shape in horizontal cross section. Optional horn reflector 104, absorptive material 108, or an adjustable aperture 114 may be added to FIG. 8 if desired (not shown).

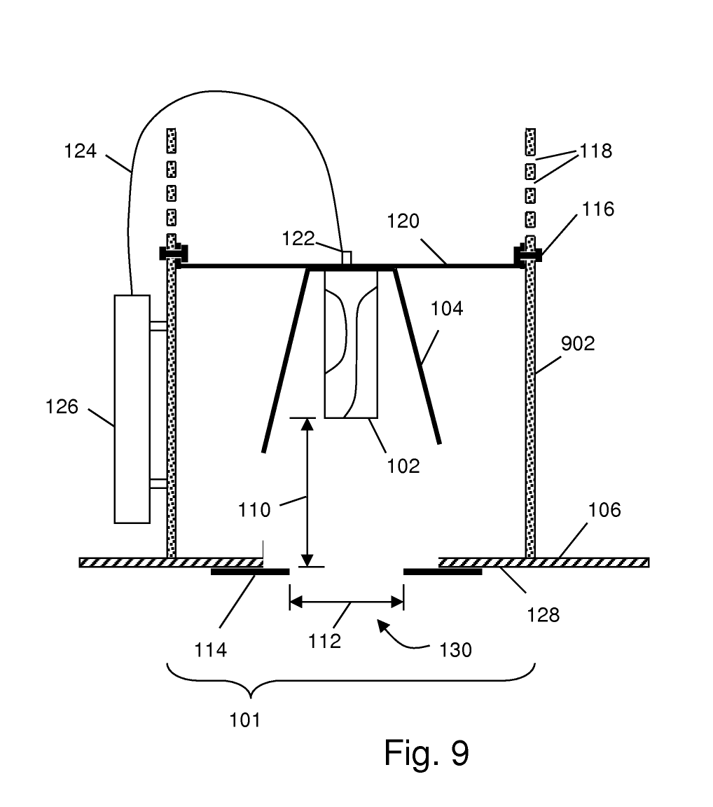

FIG. 9 shows a variation of the system of FIG. 1, wherein the shield is the end wall. The surrounding structure 902 may be plastic that may be transparent or absorptive to RF energy as desired. Absorptive material 108 may be added if necessary (not shown). It may be desirable to extend the end wall 128 as shown to provide greater lateral attenuation. Optional horn reflector 104 and optional aperture adjustment panels 114 may be removed if not needed.

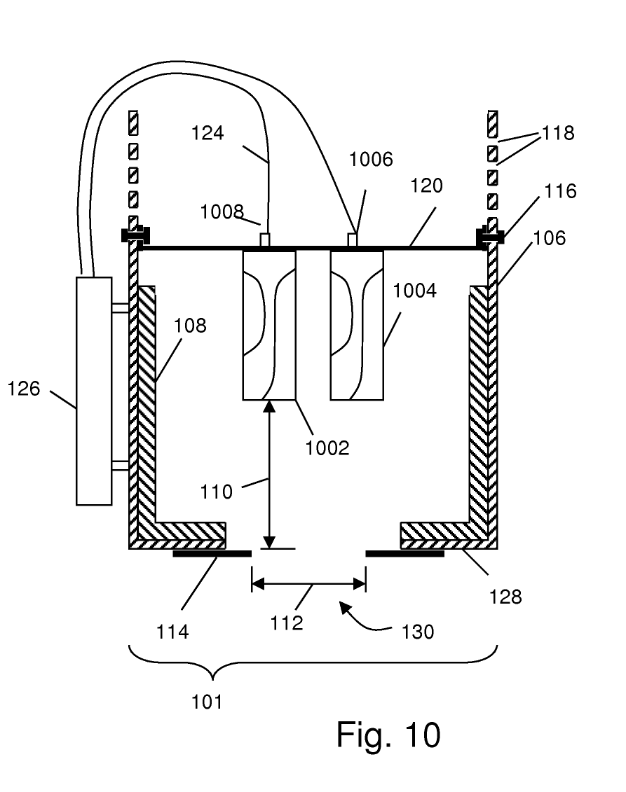

FIG. 10 shows an exemplary embodiment wherein the antenna structure comprises two antennas. Referring to FIG. 10, the antenna structure 102 may comprise more than one antenna. FIG. 10 shows the antenna structure 102 comprising two antennas 1002 and 1004 having a shifted position or alternate polarization, frequency or other response. Each antenna may have a separate feed coupling 1006, 1008. The receiver may separately receive and decode signals from the separate antennas. In one embodiment the two antennas may utilize the same aperture and may cover separate, close and possibly overlapping active zones. The separate active zones may be used for determining a direction of motion through the area by detecting which zone is first or last acquired. Alternatively, a phase or time difference between signals form the two antennas may be used for positioning within the active zone or determining direction of movement through the active zone.

In a further variation, the receiver may be configured to utilize multiple compound antennas 101 to provide multiple active zones. The multiple active zones may be combined to generate a single active zone of a more complex shape or having multiple separate regions. Alternatively the receiver may be configured to distinguish the antenna source of a received signal by multiplexing the antennas or having multiple receiver modules within the receiver. Thus separate functions may be attributed to each active zone. For example, each active zone may monitor separate doorways. Two active zones may monitor two sides of a doorway (inside, outside), thus allowing direction of movement, entering or exiting the room, to be determined. Further, multiple receivers may be networked or otherwise in communication to form a monitoring system covering an entire facility—providing facility wide security, employee tracking, asset tracking, and/or other functions as the application demands.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof. Relative terms such as vertical, horizontal, width, length, and height are used for convenience of description within the given context. The invention may be used in any orientation and such terms may be interchanged accordingly. The antenna system coverage area may be referred to variously as illumination area or other terminology; however, the system may be used with receivers, transmitters, or transceivers, the tags or devices in communication with the system may be active or passive or include elements of both. Exemplary ranges suggested are intended to include any subrange consistent with the disclosure.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A compound antenna system having a sharply defined coverage zone, comprising:
an antenna structure having a feed point for coupling signals to and from said compound antenna system; and
a shield structure;
said shield structure disposed or extending forward from said antenna structure toward said coverage zone; said shield structure having an open aperture between said antenna structure and said coverage zone; said open aperture configured for allowing direct line of sight radio frequency communication between said antenna structure and objects within said coverage zone;
said shield structure configured for providing radio frequency attenuation and/or blocking for signals from or to objects outside of said coverage zone;
wherein an edge of said shield structure is aligned between said antenna structure and an edge of said coverage zone.

2. The compound antenna system of claim 1, further including an RF absorbing material disposed between said shield structure and said antenna structure for attenuating signals from or to objects outside of said coverage zone.

3. The compound antenna system of claim 1, wherein the antenna structure has a directionality greater than a dipole.

4. The compound antenna system of claim 3, further including a tapered horn reflector coupled to said antenna structure to enhance a directionality of said antenna structure.

5. The compound antenna system as recited in claim 1, wherein said antenna structure is capable of receiving ultra-wideband signals.

6. The compound antenna system as recited in claim 1, wherein said antenna structure comprises a Vivaldi antenna structure.

7. The compound antenna system as recited in claim 1, wherein said open aperture is formed at least in part by at least one adjustable panel.

8. The compound antenna system as recited in claim 1, wherein said antenna spacing from said open aperture is adjustable by varying an antenna mounting distance from said open aperture within said shield structure.

9. The compound antenna system as recited in claim 1, wherein said open aperture is spaced at least one wavelength from an antenna phase center of said antenna structure.

10. The compound antenna system as recited in claim 1, wherein said open aperture is at least two wavelengths in a length dimension.

11. The compound antenna system as recited in claim 1, wherein said open aperture defines a perimeter shape of said coverage zone.

12. The compound antenna system as recited in claim 1, wherein said antenna structure is configured for communicating linearly polarized or circularly polarized signals.

13. The compound antenna system in accordance with claim 1, further including
a receiver system coupled to said compound antenna system, said receiver system configured for receiving a received signal from a transmitter within said coverage zone of said compound antenna system and for processing said signal based on a received amplitude of said received signal exceeding a predetermined threshold.

14. The compound antenna system as recited in claim 13, wherein said predetermined threshold is adjustable.

15. The compound antenna system as recited in claim 14, wherein said adjustable threshold is set based on a maximum response within said active zone.

16. The compound antenna system as recited in claim 14, wherein said adjustable threshold is separately adjusted for at least one transmitter based on an identification of said transmitter.

17. The compound antenna system as recited in claim 14, wherein the threshold is based on a maximum signal amplitude slope as a function of a path through said active zone.

18. A method of producing a sharply defined coverage zone for an antenna structure, comprising:
directing said antenna structure toward said coverage zone;
producing a compound antenna system by:
positioning a shield structure, at least in part, forward from said antenna structure toward said coverage zone;
providing an open aperture through said shield structure, said open aperture allowing direct line of sight radio frequency communication between said antenna structure and objects within said coverage zone;
configuring said shield structure to provide radio frequency attenuation and/or blocking for signals form or to objects outside of said coverage zone; and
aligning an edge of said shield structure between said antenna structure and an edge of said coverage zone for enhancing a response slope of said compound antenna structure.

19. The method in accordance with claim 18, further including a step of:
positioning RF absorbing material between said shield structure and said antenna structure for attenuating signals from or to objects outside of said coverage zone.

20. The method in accordance with claim 18, further including a step of:
adding a directive element to said antenna structure to enhance the directionality of said antenna structure.

21. The method in accordance with claim 18, wherein said antenna structure is capable of receiving ultra-wideband signals.

22. The method in accordance with claim 18, further including a step of:
adjusting said open aperture by adjusting a panel forming said open aperture.

23. The method in accordance with claim 18, further including a step of:
spacing said open aperture at least one wavelength from an antenna phase center of said antenna structure.

24. The method in accordance with claim 18, further including a step of:
forming said open aperture at least two wavelengths in a length dimension.

25. The method in accordance with claim 18, further including a step of:
forming said open aperture to define a perimeter shape of said coverage zone.

26. The method in accordance with claim 18, further including a step of:
receiving a signal from a transmitter within said coverage zone of said compound antenna system and for processing said signal based on a received amplitude of said received signal exceeding a predetermined threshold.

27. The method in accordance with claim 26, further including a step of:
adjusting said threshold.

28. The method in accordance with claim 26, further including a step of:
adjusting said threshold based on a maximum response within said active zone.

29. The method in accordance with claim 26, further including steps of:
determining an identification of a transmitter;
accessing a memory for a historical property associated with said transmitter; and
adjusting said threshold in accordance with said historical property.

30. The method in accordance with claim 26, further including steps of:
determining a maximum signal amplitude slope as a function of a path through said active zone; and
adjusting said threshold in accordance with said maximum signal amplitude slope.
